(19) United States
(12) Patent Application Publication
(10) Pub. No.: US 2004/0261110 A1
(43) Pub. Date: Dec. 23, 2004

(54) Lodging entertainment system with guest controlled integrated receiver decoder

(75) Inventors: Gary Kolbeck, Sioux Falls, SD (US); Peter F. Klebanoff, Sioux Falls, SD (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: LodgeNet Entertainment Corporation, Sioux Falls, SD

(21) Appl. No.: 10/847,784

(22) Filed: May 17, 2004

Related U.S. Application Data
(60) Provisional application No. 60/480,996, filed on Jun. 23, 2003.

(51) Int. Cl. H04N 5/445; H04N 7/20; H04N 7/18

(52) U.S. Cl. 725/78; 725/74; 725/63; 725/39

(57) ABSTRACT

A lodging entertainment system has a head end connected via a distribution system to a plurality of guest terminals. The head end includes a satellite dish and a plurality of integrated receiver decoders connected to the satellite dish for decoding programming received from the satellite dish. The lodging entertainment system includes a method for providing an interactive session between a guest terminal and a selected one of the integrated receiver decoders. In implementing this method, the system receives buy data indicative of a guest's purchase of programming available via the satellite dish. The system then allocates a selected one of the integrated receiver decoders for exclusive use by the guest terminal. The system then provides the guest terminal with access to and control of the selected integrated receiver decoder.

### CROSS-REFERENCE TO RELATED APPLICATION(S)

This application claims the priority from provisional U.S. patent application 60/480,996, filed on Jun. 23, 2003 for “Lodging Entertainment System With Guest Controlled Integrated Receiver Decoder” of Gary Kolbeck and Peter F. Klebanoff, which application is hereby incorporated by reference in its entirety.

### BACKGROUND OF THE INVENTION

The present invention relates to systems that provide in-room entertainment at hotels and other lodging facilities. In particular, the present invention is a method and system of providing access to and control of an integrated receiver decoder to a guest terminal in a lodging entertainment system.

The past two decades have seen the wide scale introduction of entertainment systems in hotels and other lodging facilities. These systems provide a variety of services to the guest through the guest room television. The services typically include regular off-air television programs, pay-per-view movies, Internet access, and guest services such as video shopping and video checkout.

A typical hotel entertainment system contains a head end, a distribution system, and guest terminals located in each of the guest rooms. The head end includes devices to generate entertainment content such as movies and video games, as well as devices to provide Internet access and generate interactive menus and other services. The head end also includes modulators necessary to place the television signals, generally received via satellite transmission through an integrated receiver decoder, from the various sources on to the appropriate channels for transmission through the distribution system to the guest terminals. A host computer coordinates operation of the entertainment system by receiving key stroke information from the guest terminals and controlling operations of various sources of television signals so that the guest receives the entertainment or services which he or she has requested.

Some hotel entertainment systems today now include in each of the guest rooms a digital set-top box capable of performing many of the functions previously performed at the head end.

Typically, lodging entertainment systems are not owned by the hotel, but rather are provided by a vendor who provides the head end equipment, the distribution system, and the guest terminal (including the television, remote control, game controller, keyboard, and associated control circuitry which interfaces the television to the distribution system).

In this arrangement, the entertainment system vendor owns the equipment and pays for the installation of the system in the lodging facility. The vendor must also provide the content, such as movies, games, and cable/satellite programming. The vendor receives compensation based upon amounts the hotel collects from the guest for pay-per-view movies, games, Internet access, and other services for which charges are made. The hotel usually receives a percentage of the guest charges. In addition, the content sources, such as motion picture studios and game program vendors, receive royalties for movies and games which are viewed and played by a guest.

In many cases, a guest may chose not to purchase any of the services being offered through the entertainment system. The amount of purchases depends upon the popularity of the movies and other products/services being offered, vacancy rates at the hotel, the demographics of the guests, and the extent of free offerings available through the entertainment system.

There is a continuing need for new and improved offerings which will result in higher purchase rates through the lodging entertainment system. At the same time, any additional products/services which also require significant increases in capital investment in the entertainment systems are difficult to justify. For example, if a new service will require additional capital equipment to be installed in every guest room, or will require the addition of expensive hardware or software at the head end, the total cost of the additional hardware and software must be weighed against the increase in purchases which can be expected from the additional capital investment.

### BRIEF SUMMARY OF THE INVENTION

A lodging entertainment system has a head end connected via a distribution system to a plurality of guest terminals. The head end includes a satellite dish and a plurality of integrated receiver decoders connected to the satellite dish for decoding programming received from the satellite dish. The lodging entertainment system includes a method for providing an interactive session between a guest terminal and a selected one of the integrated receiver decoders. In implementing this method, the system receives buy data indicative of a guest's purchase of programming available via the satellite dish. The system then allocates a selected one of the integrated receiver decoders for exclusive use by the guest terminal. The system then provides the guest terminal with access to and control of the selected integrated receiver decoder.

### BRIEF DESCRIPTION OF THE DRAWINGS

FIGS. 1A and 1B are a block diagram showing a system overview of a hotel entertainment system in accord with the present invention.

FIG. 2 is a flow chart illustrating the method of the present invention.

FIGS. 3-6 are exemplary embodiments of menu screens for use in system of the present invention.

### DETAILED DESCRIPTION

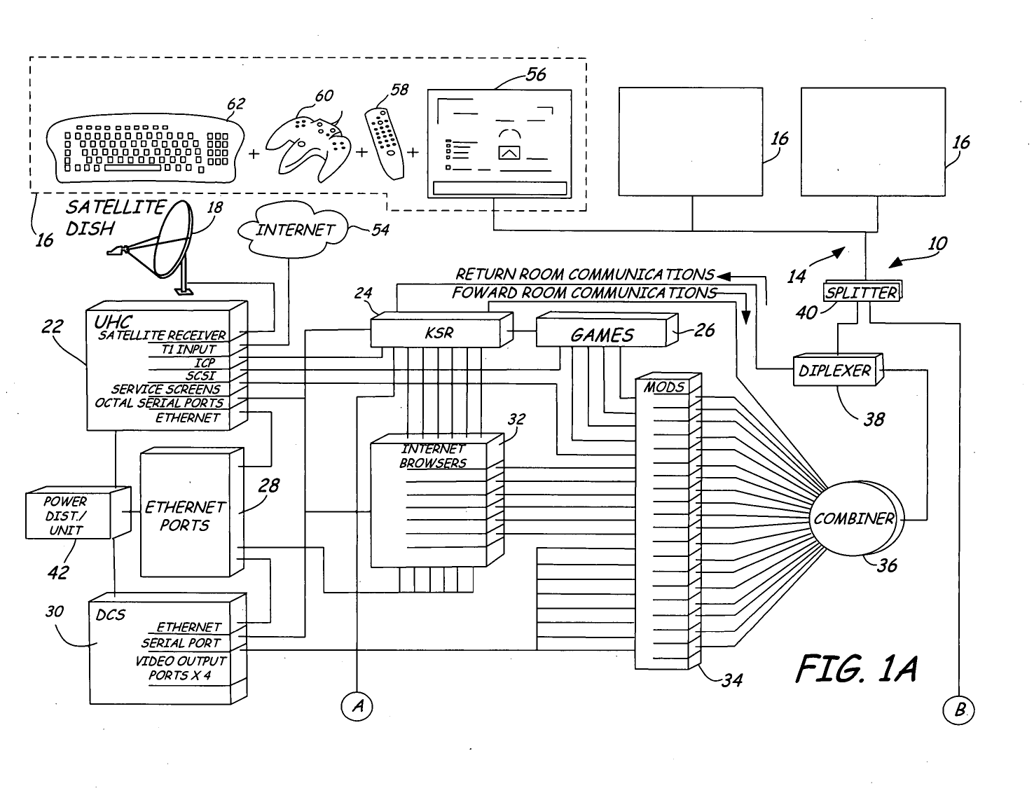

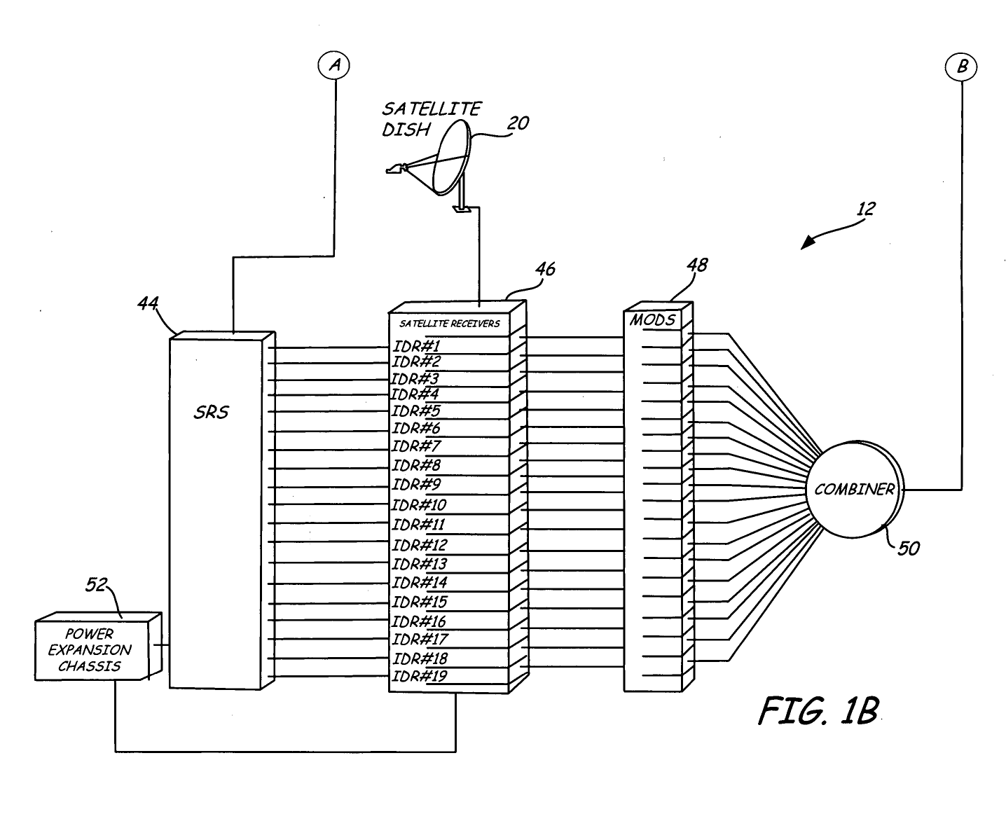

FIGS. 1A and 1B are a block diagram showing a system overview of a hotel entertainment system in accord with the present invention. The hotel entertainment system delivers television programming, digital music, video-on-demand (VOD) movies, interactive video games, Internet access, and other interactive video services to individual guest rooms of a hotel or other lodging facility. Among the services offered to the guest is individual access to and control of an integrated receiver decoder (IRD). The entertainment system includes five primary portions: a head end comprised of first head end rack 10 and second head end rack 12, distribution system 14, guest terminals 16, proprietary satellite dish 18 and content satellite dish 20. First head end rack 10, distribution system 14, guest terminals 16, and proprietary satellite dish 18 are each illustrated in FIG. 1A, while second head end rack 12 and content satellite dish 20 are each illustrated in FIG. 1B.

Audio/video RF signals for all channels of the hotel entertainment system are provided from the head end. The audio/video RF signals from the head end may include off-air local television channels, direct broadcast satellite programing, interactive menus and program guides, digital music, VOD programming, interactive video games, Internet services, and other interactive video and multi-media services. Based upon system control data transmitted and received via distribution system 14 from guest terminals 16, the head end controls the operation of interactive menus and program guides, digital music, VOD movies, interactive games, Internet services, and other interactive services.

Distribution system 14 is preferably an MATV cable distribution system conventionally used in hotels and other lodging facilities. Distribution system 14 permits the transmission of both audio/video RF signals, as well as two-way data and digital communication (typically RF) signals between the head end and guest terminals 16.

First head end rack 10 includes UNIX host computer (UHC) 22, keystroke router (KSR) 24, game platform 26, digital content server (DCS) 28, Ethernet ports 30, Internet browsers 32, first bank of modulators 34, first combiner 36, diplexer 38, splitter 40, power distribution unit 42. Second head end rack 12 includes satellite receiver supervisor (SRS) 44, IRDs 46, second bank of modulators 48, second combiner 50, and power expansion chassis 52.

Host computer 22 is, in a preferred embodiment, a computer which runs UNIX operating code, together with software for coordinating the operations of components of the head end. Host computer 22 houses several different computer cards and components. In the embodiment shown in FIG. 1, host computer 22 includes a satellite receiver, a T1 interface card, an intelligent communications processor (ICP) card, a SCSI interface card, an Ethernet card, an eight port serial card, and a number of interactive video port cards. In addition, host computer 22 also houses storage devices such as a floppy disk drive, a backup drive, a CD ROM drive, and a hard disk drive.

Host computer 22 communicates with proprietary satellite dish 18 using TCP-IP protocol over a coaxial cable connected to the satellite receiver of host computer 22. Proprietary satellite dish 18 receives digital information from the entertainment system vendor, including software upgrades, digital entertainment content such as digital music and VOD movies, and content scheduling information.

Host computer 22 is in charge of polling all of the guest terminals 16 for keystroke activity. The polling function is performed by the ICP of host computer 22 through keystroke router 32. The ICP of host computer 22 communicates with keystroke router 32 over a serial line. The results of the polling are received back from guest terminal 16 over distribution system 14 and are routed through splitter 52 to diplexer 50, and then to keystroke router 32. Depending upon the particular keystrokes that are returned, keystroke router 32 will return the keystrokes to the serial card of host computer 22; to game platform 26, digital content server 28, or Internet browsers 32 through serial lines, to SRS 36 through serial lines, or to other services which may be implemented.

Host computer 22 communicates with game platform 26 by a high speed serial line between the SCSI port of host computer 22 and game platform 26. For example, game programs stored by host computer 22 may be downloaded to individual game engines of game platform 26 based upon game ordering and selection made by the guest through guest terminals 16.

Host computer 22 communicates through its Ethernet card with Ethernet ports 28, which in turn communicate with both digital content server 30 and Internet Browsers 32 through an Ethernet connection. Host computer 22 provides a communication interface between the head end and each of proprietary satellite dish 18 and Internet 54. Host computer 22 communicates with Internet 54 over a T1 line connected to the T1 interface card of host computer 22. Host computer 22 communicates audio and video information between Internet 54 to Internet browsers 32 via Ethernet ports 28, and also communicates digital entertainment data received from proprietary satellite dish 18 to digital content server 30 via Ethernet ports 28.

The interactive ports of host computer 22 provide audio and video associated with menuing, program guides and other interactive services. These include guest services such as interactive content controls, video checkout, interactive shopping, surveys, opinion polls, and room service ordering. The interactive ports may also provide a wide variety of different audio and video programs to a subscriber, including, for example, video directories, advertising, and other information services.

The outputs of the interactive ports of host computer 22, as well as the outputs of game platform 26, digital content server 30, and Internet browsers 32 are baseband audio/video signals which are provided to inputs of first bank of modulators 34, which in turn connects to first combiner 36, diplexer 38, splitter 40 and onto distribution system 14 to guest terminals 16.

Game platform 26 is a device that allows a guest to purchase an interactive video game and to view that game at guest terminal 16. Game platform 26 receives information from host computer 22 from the SCSI card of host computer 22. Keystrokes from guest terminal 16 and intended for game platform 26 are received by keystroke router 24 and routed to the specific game engine of game platform 26 corresponding to the guest who has sent the keystroke. The audio and video output ports of game platform 26 are connected to selected first modulators 34.

Digital content server 30 includes digital storage (e.g., a RAID hard disc array) with storage capacity to store all desired program content to be offered to the guest. This includes, for example, movies, music, web cinema, pre-recorded broadcast programs from a central site, and guest-selected programs recorded for time-shifted viewing. The content is stored in files in the digital storage, and each type of service has its own directory where its content is stored. The overall storage space is shared among the various services. The content is stored in an encoded format such as MPEG-2. Digital content server 30 includes decoders for converting the stored content to baseband audio/video during playback. The outputs of digital content server 30 are output ports which are connected to selected first modulators 34.

Internet browsers 32 send audio and video information from Internet 54 to the appropriate guest terminal 16. The outputs of Internet browsers 32 are connected to selected first modulators 34, so that the audio and video is placed on a channel to which the guest terminal 16 of the guest conducting the Internet session is tuned.

SRS 44 and IRDs 46 work together both to provide free to guest (FTG) satellite programming to guest terminals 16 and to allow a guest to purchase entertainment content from a guest controlled IRD. SRS 44 controls the operation of IRDs 46 such that selected ones of IRDs 46 are programmed to receive specific content from content satellite dish 20 to be provided as FTG programming. SRS 44 also works with IRDs 46 to provide an exclusive interactive session between guest terminal 16 and a selected one of IRDs 46. During this interactive session, SRS 44 allows for selective tuning by the guest terminal 16 of the selected IRD 46. Also during this interactive session, keystrokes received from guest terminal 16 via keystroke router 24 are routed to an appropriate one of IRDs 46 which corresponds to the guest terminal 16 of the guest conducting the guest controlled IRD session. For both the FTG programming, and the guest controlled RD programming, IRDs 46 receive and decode satellite programming received from content satellite dish 20. IRDs 46 then supply the satellite programming to one or more of second bank of modulators 48.

First modulators 34 convert baseband video and audio signals received at their inputs to RF signals and deliver the RF signals to first combiner 36, which in turn delivers the RF signals to diplexer 38, to splitter 40. Similarly, second modulators 48 convert baseband video and audio signals received at their inputs to RF signals and deliver the RF signals to second combiner 50. Each modulator is set to modulate on a specific frequency or RF channel.

The outputs of first modulators 34 are connected to the inputs of first combiner 36. The output of first combiner 36 is connected to the input of diplexer 38. The outputs of second modulators 48 are connected to the inputs of second combiner 50. The outputs of diplexer 38 and second combiner 50 are each connected to splitter 40 which provides the RF signals from first combiner 36 and second combiner 50 onto distribution system 14 to guest terminals 16. Diplexer also receives keystrokes from guest terminals 16 via distribution system 14 and routes those keystrokes to keystroke router 24.

First modulators 34 and second modulators 48 are each programmed to different channels so that there is no channel overlap between the entertainment content provided by host computer 22, games platform 26, digital content server 30, Internet browsers 32, and IRDs 46.

Power distribution unit 42, among other functions, provides power to host computer 22, Ethernet ports 28, and digital content server 30, while power expansion chassis 52, among other functions, provides power to SRS 44 and IRDs 46.

Guest terminal 16 includes television 56, remote control 58, game controller 60, keyboard 62. Each television 56 has a television screen for viewing, and has an associated television tuner and a control card which interfaces guest terminal 16 with distribution system 14 and head end 12.

The control card of guest terminal 16 receives keystrokes from remote control 58, game controller 60, and keyboard 62. In the case of remote control 58, the keystrokes are in the form of infrared signals which are transmitted from an infrared transmitter within remote control 58 to an infrared receiver associated with television 56. The keystrokes are passed by the control card to distribution system 14 back to first head end rack 10. The guest selects options by viewing interactive menus on the screen of television 56 and pressing keys of remote control 58 accordingly. These key presses are received and stored by the control card. In response to polling signals from first head end rack 10, the control card provides system data representing the keystrokes to first head end rack 10 which indicates which key or keys have been pressed.

Video game controller (or game paddle) 60 is connected by a cable to television 56. Alternatively, game paddle 56 can be connected via an IR link. Keystrokes from game paddle 56 are supplied to the control card, and then are supplied as part of system data in response to polling of guest terminals 16 by first head end rack 10. In some embodiments, game paddle 60 includes keys which duplicate keys on remote control 58 so that game paddle 60 can be used to initiate interactive sessions and order programs without the need to use remote control 58.

Keyboard 62 is connected to television 56 either through a cable or by an IR link. Keystrokes from keyboard 62 are supplied by the control card of guest terminal 16 to first head end rack 10 in response to polling. Keyboard 62 is useful for interactive services such as Internet, e-mail and computer games. Keyboard 62 can, in some cases, be used to initiate interactive sessions, order programs or select programs to be recorded, rather than using remote control 58.

When a guest wishes to use the lodging entertainment system of the present invention, the guest presses a key on remote control 58 to turn on television 56. A welcome screen will first appear on the TV screen of guest terminal 16. If the guest wishes to view off-air or satellite programming which is free programming, those channels are accessible by pressing the channel up or channel down keys on remote control 58. If, on the other hand, the guest wishes to view and perhaps select other offerings of the system, such as digital music, VOD movies, Internet access, interactive video games, recording of broadcast programs for time-shifted viewing, guest controlled IRD, or interactive services, the welcome channel screen provides an instruction to the user to select a menu. Upon pressing the menu key, a signal is provided to the control card of television 56, which stores the keystroke information until the next time that guest terminal 16 is polled by first head end rack 10. In response to polling, the keystroke indicating pressing of the menu key is supplied to first head end rack 10. This results in host computer 22 selecting one of the interactive ports internal to host computer 22 to display a series of interactive menus which are navigated by the guest through the use of keystrokes supplied by remote control 58 (or alternatively game paddle 60 or keyboard 62). Depending upon the selections made by the guest in response to the screens which are displayed, host computer 22 will activate the requested service which may be provided by game platform 26, digital content server 30, Internet browsers 32, IRDs 46, or the interactive ports of host computer 22. The selected output is routed to a modulator of first and second modulators 34 and 48 representing one of the available channels and sends digital control signals to the control card of guest terminal 16 to cause guest terminal 16 to tune to the channel on which the requested service is to appear.

The requested service can be provided to guest terminal 16 on any of a number of purchase models based upon various “buy criteria”. For example, the system may provide guest terminal 16 with exclusive control of an IRD of IRDs 46 for the selective purpose of viewing NFL SUNDAY TICKET™ channels for a fixed time period such as six hours, 24 hours or until check out. The requested service may also be provided on a “use” basis, where time of actual use of the requested service is monitored, and the access is denied after the time of use exceeds a purchased time period. These examples of buy criteria are presented as examples only, and are not contemplated to be an exhaustive list of the types of buy criteria for which access to the interactive session between guest terminal 16 and selected IRD 46 can be provided.

It is contemplated that the hotel entertainment system of the present invention may be used in various configurations, and the above-described embodiment is provided by way of example only. For instance, in a digital system where the distribution system communicates digital information to guest terminal 16 rather than analog RF signals, guest terminal 16 may include a digital set top box for performing many of the functions described above as being performed by the head end. In such a digital system, the distribution system, rather than being an MATV cable distribution system, may be CAT3, CAT5 or plain telephone wire.

The present invention provides for the hotel entertainment system to add additional offerings, thus resulting in higher purchase rates, without requiring a significant increase in capital investment required for hotel entertainment system 10. Specifically, the present invention provides hotel guests with access to programming not provided in the free-to-guest (FTG) channel lineup of each guest terminal 16.

Over 500 different channels can be provided to the hotel via a satellite dish or digital cable system. However, it is not economically feasible for the entertainment system vendor to provide that many FTG channels since the vendor's goal is to sell entertainment content. Moreover, in an analog system such as that illustrated in FIGS. 1A and 1B, bandwidth issues in distribution system 14 prevent the distribution of all 500 channels to guests. To allow for the sale of entertainment content to guests, several channels of the entertainment system are reserved for “on-demand” display of movies and other content. Thus, access to and control of an IRD 46 can be provided to a guest via a reserved channel.

The present invention allows for access to and control of a selected one of IRD 46. By providing the guest access to and control of a selected IRD, the present invention allows a guest to purchase a variable number of special event channels. For example, the guest may purchase a sports package, such as NFL SUNDAY TICKET™, ESPN FULL COURT PRESS™, or NBA LEAGUE PASS™, a movie package, such as HBO™ or ENCORE™, premium pay per view events such as concerts or boxing matches, or any single or bundled package of satellite programming channels available on IRDs 46. The head end, specifically host computer 22 and SRS 44, allocates a single “guest-controlled” IRD to a selected guest terminal 16 through which that guest terminal 16 can access programming not generally accessible over distribution system 14. In one embodiment, SRS 44 controls this interactive session between the guest terminal and the guest-controlled IRD to provide access only to guest-purchased channels.

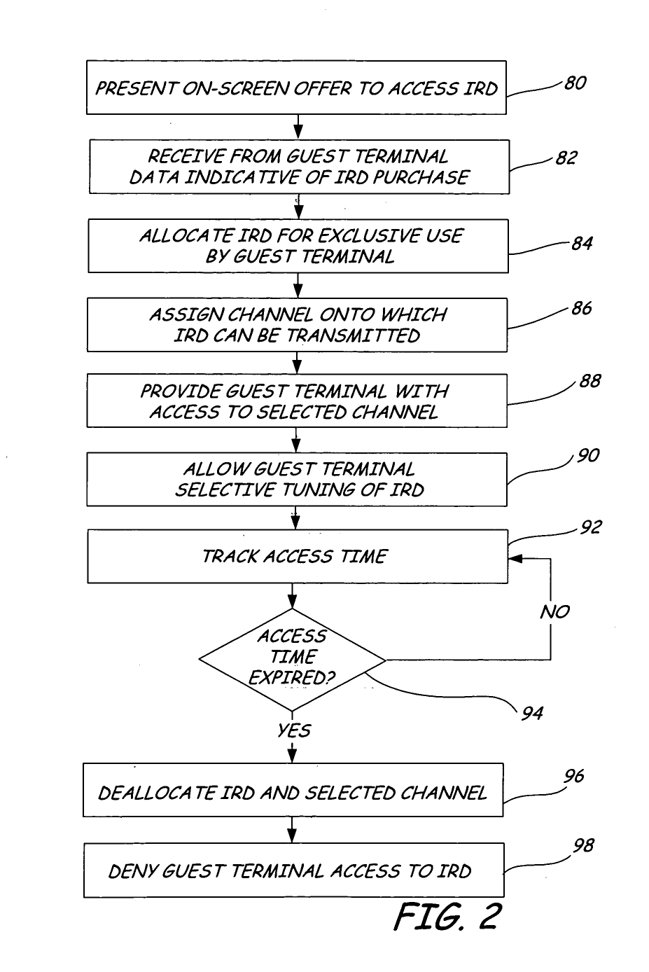

FIG. 2 is a flow chart illustrating the method of the present invention for providing access to and control of an IRD to a specific guest terminal 16. At step 80, guest terminal 16 is presented with on-screen offer to access an IRD. At step 82, data is received from guest terminal 16 indicative of the guest's desire to purchase a guest-controlled IRD. At step 84, one IRD of IRDs 46 is allocated for exclusive use by selected guest terminal 16. At step 86, a channel onto which the allocated IRD can be transmitted is allocated for exclusive use by guest terminal 16.

At step 88, the selected guest is provided access to the selected channel, for example, by force tuning guest terminal 16 to the selected channel. At step 90, the guest is provided selective control of the selected IRD. Specifically, the audio and video signals received and decoded by the selected IRD will be transmitted over the selected channel. The selected guest terminal will be provided access to the allocated channel so that the guest may view the IRD programming. Control keystrokes sent from selected guest terminal 16 will be transmitted to the head end. At the head end, keystroke router 24 will pass the received keystrokes onto SRS 44, which in turn will be passed onto the selected IRD to move through the purchased content. Access to only the purchased content can be monitored by creating a digital file maintained in the head end to associate selected guest terminal 16 with selected RD 46 and programming by guest terminal 16.

At step 92, head end tracks access time by guest terminal 16. At step 94, the access time by guest terminal 16 is evaluated to determine if the access time has expired. Access time is continuously tracked and evaluated for expiration. Once the access time has expired, at step 96, the selected IRD and channel are deallocated. Finally, at step 98, access to the IRD by guest terminal 16 is denied.

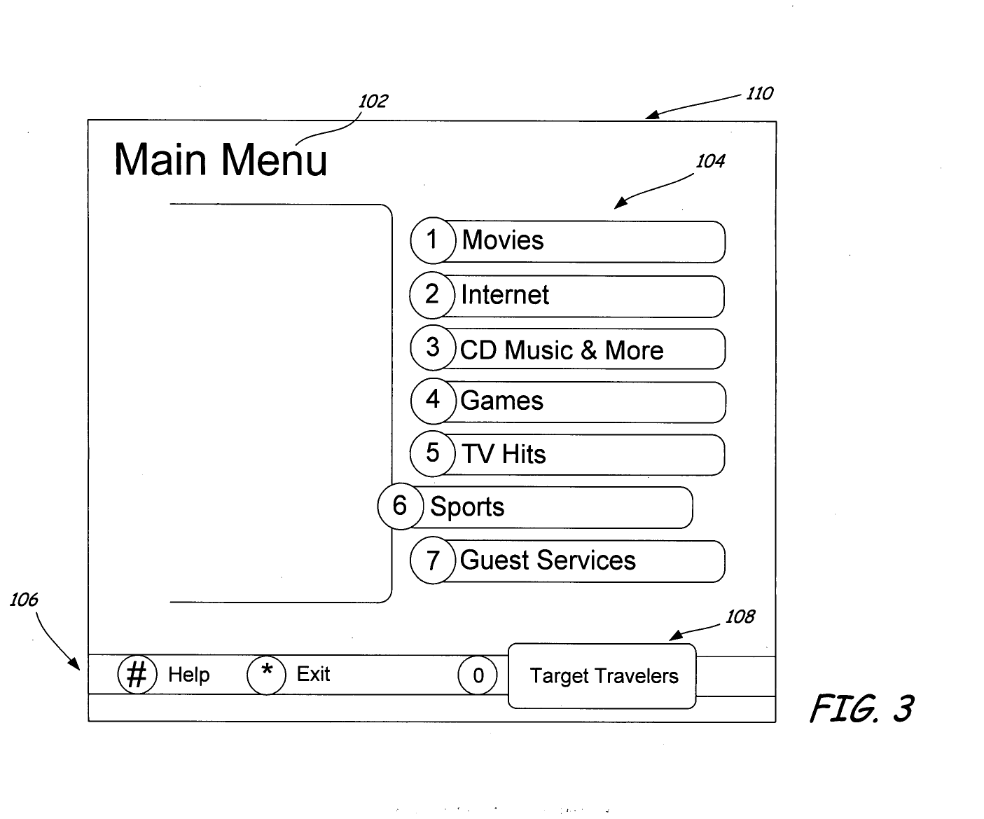

FIGS. 3-6 are exemplary embodiments of graphical user interfaces (GUI), or interactive menus, displayed on a selected one of guest terminals 16 for use in accessing an interactive session between selected guest terminal 16 and a selected one of IRDs 46. FIGS. 3-6 are each made up of at least one of the following elements: title bar 102, menu options 104, navigation options 106, promotional message 108, and description 109. Content summary 100 provides a summary of the content available in the purchased bundle of channels. Title bar 102 provides navigational information to inform the guest which GUI is presently being displayed. Menu options 104 present the guest with a list of selectable content options, such that selection of any one of menu options 104 presents the guest with corresponding submenu. Navigation options 106 present the guest with selectable navigation options that allow the guest to navigate their way through the menu screens or to exit the interactive menu session and return to FTG programming. Promotional message 108 presents the guest with a selectable option of viewing an advertising message. A rollover bar may be used to allow for easier navigation of menu options 104, navigation options 106 and promotional message 108. In order for the guest to select any one of menu options 104, navigation options 106, or promotional option 108, the guest can press the corresponding number button on the remote control, or can move the rollover bar to the desired selection by pressing the directional buttons on the remote control. Each option within menu options 104, navigation options 106, and promotional message 108 can be implemented with a picture icon, or “picon”, or with a text selection. Description 109 presents a textual description of a selection content viewing option.

FIG. 3 illustrates interactive main menu 110 which includes title bar 102, menu options 104, navigation options 106, and promotional message 108. Title bar 102 informs the guest that the “Main Menu” GUI is presently being displayed. Menu options 104 present the guest with a list of selectable content options: “Movies”, “Internet”, “CD Music & More”, “Games”, “TV Hits”, “Sports”, and “Guest Services.” Navigation options 106 present the guest with selectable navigation options: “Help” and “Exit.” In FIG. 3, a rollover menu is used to navigate menu options 104, navigation options 106, and promotional message 108, with the rollover menu indicating the presently selected option of “Sports” by offsetting the “Sports” picon from the picons of the remaining options. The guest may also select a specific option by pressing the corresponding number button on the remote control.

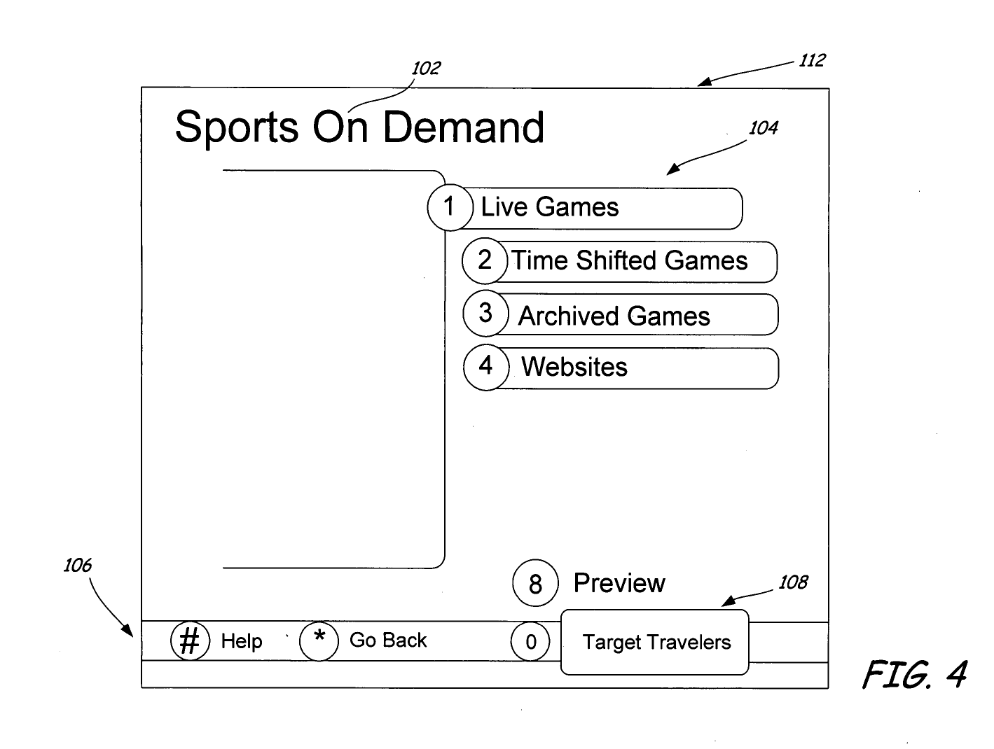

FIG. 4 illustrates interactive submenu 112 having title bar 102, menu options 104, navigation options 106, and promotional message 108. Submenu 112 is reached by selecting the “Sports” navigation option of GUI 110 of FIG. 3. Title bar 102 informs the guest that the “Sports On Demand” GUI is presently being displayed. Menu options 104 present the guest with a list of selectable content options: “Live Games”, “Time-Shifted Games”, “Archived Games”, and “Websites”. Navigation options 106 present the guest with selectable navigation options: “Menu”, “Go Back”, and “Preview.”

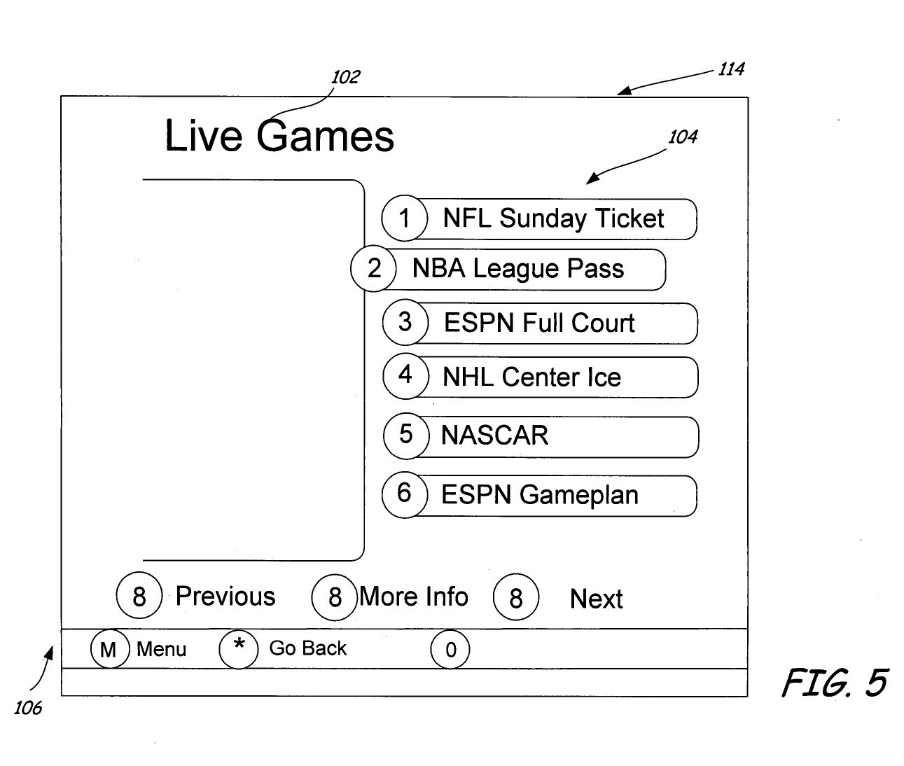

FIG. 5 illustrates interactive submenu 114 having title bar 102, menu options 104, and navigation options 106. Submenu 114 is reached by selecting the “Live Games” navigation option of GUI 112 of FIG. 4. Title bar 102 informs the guest that the “Live Games” GUI is presently being displayed. Menu options 104 present the guest with a list of selectable content options: “NFL SUNDAY TICKET™”, “NBA LEAGUE PASS™”, “ESPN FULL COUR™”, “NHL CENTER ICE™”, “NASCAR”, and “ESPN GAMEPLAN™”. Navigation options 106 present the guest with selectable navigation options: “Menu”, “Go Back”, “Previous”, “More Info”, and “Next”.

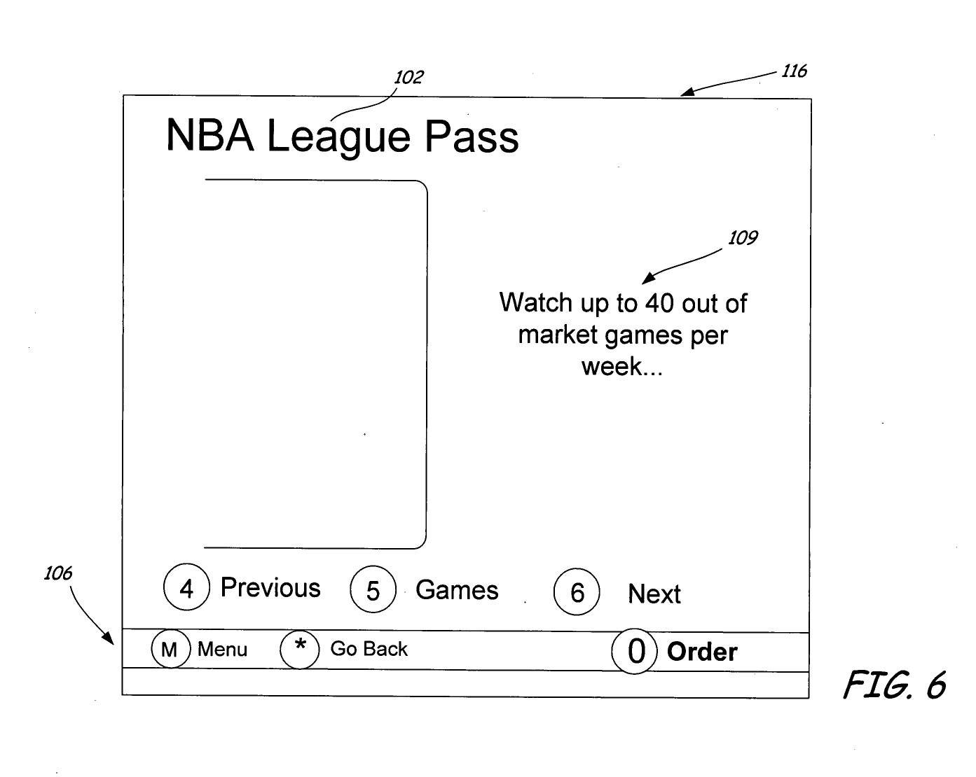

FIG. 6 illustrates interactive submenu 116 having title bar 102, navigation options 106, and description 109. Submenu 116 is reached by selecting the “NBA LEAGUE PASS™” navigation option of GUI 114 of FIG. 5. Title bar 102 informs the guest that the “NBA LEAGUE PASS™” GUI is presently being displayed. Navigation options 106 present the guest with selectable navigation options: “Menu”, “Go Back”, and “More Info”. Description 109 provides a detailed textual description of the programming available in the selected bundle of channels, in this case, “NBA LEAGUE PASS™”.

In each of the GUI's illustrated in FIGS. 3-6, navigation options 106 may include “Exit”, “Menu”, “Help”, “Preview”, “Go Back”, “Previous”; “Next”, and “Order”. Selection of the “Exit” option exits the guest from the interactive menu session; selection of “Menu” takes the guest back to interactive main menu 110; selection of “Help” presents the user with a help screen; selection of “Preview” presents the guest with a short preview of the content associated with the corresponding menu; selection of “Go Back” takes the guest back to the previous GUI; selection of “Previous” takes the guest to the GUI associated with the previous content option of menu options 104 of the previous GUI; selection of “Next” takes the guest to GUI associated with the next content option of menu options 104 of the previous GUI; and selection of “Order” presents the guest with a buy screen GUI from which the guest can confirm purchase of the selected content.

Thus, a guest navigating between interactive menus 1110, 112, 114, and 116 would proceed as follows. To access interactive submenu 112 from interactive main menu 110, the guest would select the “Sports” option of menu options 104 of main menu 110. To next access interactive submenu 1114, the guest would select the “Live Games” option of menu options 104 of submenu 1112. To access interactive submenu 116, the guest would select the “NBA LEAGUE PASS™” option of menu options 104 of submenu 114. From interactive submenu 116, the guest's selection of the “Previous” option of navigation options 106 would access the “NFL SUNDAY TICKET™” submenu listed on submenu 114, while selection of the “Next” option would access the “ESPN FULL COURT™” submenu.

In sum, the present invention provides a method for providing a guest with access to and control of an integrated receiver decoder to provide additional offerings on a hotel entertainment system. Thus, the present invention will result in higher purchase rates, without requiring a significant increase in capital investment required for the hotel entertainment system.

Although the present invention has been described with reference to preferred embodiments, workers skilled in the art will recognize that changes may be made in form and detail without departing from the spirit and scope of the invention.

1. In a lodging entertainment system having a head end connected via a distribution system to a plurality of guest terminals, wherein the head end includes a satellite dish and a plurality of integrated receiver decoders connected to the satellite dish for decoding programming received from the satellite dish, a method for providing to one of the guest terminals control of one of the integrated receiver decoders, the method comprising:
receiving buy data indicative of a guest's purchase of programming available via the satellite dish;
allocating one of the integrated receiver decoders for exclusive use by the guest terminal; and
providing the guest terminal with access to and control of the allocated integrated receiver decoder.

2. The method of claim 1 wherein the programming available via the satellite dish comprises live sports games.

3. The method of claim 1 wherein the programming available via the satellite dish comprises bundled satellite programming channels.

4. The method of claim 1 wherein providing the guest terminal with access to and control of the allocated integrated receiver decoder comprises:
allocating a channel onto which the allocated integrated receiver decoder may transmit satellite programming to the guest terminal; and
transferring integrated receiver decoder control keystrokes received from the guest terminal to the allocated integrated receiver decoder.

5. The method of claim 4 and further comprising:
limiting the guest terminal's control of the allocated integrated receiver decoder to the purchased programming.

6. The method of claim 1 and further comprising:
tracking access by the guest terminal to the allocated integrated receiver decoder for a buy criteria.

7. The method of claim 6 and further comprising:
deallocating the allocated integrated receiver decoder and channel when the tracked buy criteria exceeds a predetermined value; and
denying the guest terminal access to the allocated integrated receiver decoder when the tracked buy criteria exceeds the predetermined value.

8. In a lodging entertainment system having a head end connected via a distribution system to a plurality of guest terminals, wherein the head end includes a satellite dish and a plurality of integrated receiver decoders connected to the satellite dish for decoding programming received from the satellite dish, a method for providing an interactive session between one of the guest terminals and one of the integrated receiver decoders, the method comprising:
receiving data indicative of a guest's decision to access selected programming received by the satellite dish;
allocating an integrated receiver decoder for exclusive use by the guest terminal;
editing a digital file corresponding to the allocated integrated receiver decoder to identify the selected programming which the guest terminal may access via the allocated integrated receiver decoder; and
providing the guest terminal with access to and control of the allocated integrated receiver decoder.

9. The method of claim 8 wherein the selected programming comprises live sports games.

10. The method of claim 8 wherein the selected programming comprises bundled satellite programming channels.

11. The method of claim 8 wherein providing the guest terminal with access to and control of the allocated integrated receiver decoder comprises:
allocating a channel onto which the allocated integrated receiver decoder may transmit the selected programming to the guest terminal; and
transferring integrated receiver decoder control keystrokes received from the guest terminal to the allocated integrated receiver decoder.

12. The method of claim 11 and further comprising:
limiting the guest terminal's control of the allocated integrated receiver decoder to the selected programming identified in the digital file.

13. The method of claim 8 and further comprising:
tracking access by the guest terminal to the allocated integrated receiver decoder for a buy criteria.

14. The method of claim 13 and further comprising:
deallocating the allocated integrated receiver decoder and channel when the tracked buy criteria exceeds a predetermined value; and
denying the guest terminal access to the allocated integrated receiver decoder when the tracked buy criteria exceeds the predetermined value.

15. In a lodging entertainment system having a head end connected via a distribution system to a plurality of guest terminals, wherein the head end includes a satellite dish and a plurality of integrated receiver decoders connected to the satellite dish for decoding programming received from the satellite dish, a method for granting a guest terminal exclusive control of one of the integrated receiver decoders, the method comprising:
providing an on-screen offer to purchase access to bundles of channels available from the satellite dish;
receiving buy data indicative of a guest's selection of a bundle of channels to which access has been purchased;
dedicating one of integrated receiver decoders for exclusive use by the guest terminal; and
providing the guest terminal with access to and control of the dedicated integrated receiver decoder.

16. The method of claim 15 wherein the bundles of channels available for purchase include live sports programming channels.

17. The method of claim 15 wherein providing the guest terminal with access to and control of the dedicated integrated receiver decoder comprises:
allocating a channel onto which the dedicated integrated receiver decoder may transmit the selected programming to the guest terminal; and
transferring integrated receiver decoder control keystrokes received from the guest terminal to the dedicated integrated receiver decoder.

18. The method of claim 17 and further comprising:
limiting the guest terminal's control of the dedicated integrated receiver decoder to the purchased bundle of channels.

19. The method of claim 15 and further comprising:
tracking access by the guest terminal to the dedicated integrated receiver decoder for a buy criteria.

20. The method of claim 19 and further comprising:
deallocating the dedicated integrated receiver decoder and channel when the tracked buy criteria exceeds a predetermined value; and
denying the guest terminal access to the dedicated integrated receiver decoder when the tracked buy criteria exceeds the predetermined value.

21. A lodging entertainment system comprising:
a plurality of guest terminals;
a distribution system connected to the guest terminals; and
a head end which communicates with the guest terminals via the distribution system, the head end being capable of providing an interactive session between a guest terminal and a selected one of a plurality of integrated receiver decoders.

22. The lodging entertainment system of claim 19 wherein the head end is further capable of monitoring for expiration of a buy criteria defining a length of the interactive session between the guest terminal and the selected integrated receiver decoder.

23. The lodging entertainment system of claim 19 wherein the head end is further capable of terminating the interactive session when the buy criteria defining the length of the interactive session has expired.

24. The lodging entertainment system of claim 19 wherein the head end is further capable limiting the interactive session to a select number of channels receivable by the integrated receiver decoder.
